(19) United States
(12) Patent Application Publication
(10) Pub. No.: US 2010/0073956 A1
(43) Pub. Date: Mar. 25, 2010

(54) HEAT DISSIPATION MODULE WITH LIGHT GUIDING FINS

(75) Inventor: PIN-CHUN CHEN, TAIPEI CITY (TW)

Correspondence Address: ROSENBERG, KLEIN & LEE, 3458 ELLICOTT CENTER DRIVE-SUITE 101, ELLICOTT CITY, MD, 21043, US

(73) Assignee: EDISON OPTO CORPORATION, TAIPEI HSIEN (TW)

(21) Appl. No.: 12/235,878

(22) Filed: Sep. 23, 2008

(51) Int. Cl. F21V 8/00; F21V 29/00

(52) U.S. Cl. 362/555; 362/580

(57) ABSTRACT

A heat dissipation module being applied to guide at least one illumination light beam projected from at least one light emitting member, and being applied to release heat energy when projecting the illumination light beam is disclosed in the present invention. The heat dissipation module comprises a heat dissipation base, a plurality of heat dissipating fins, and a plurality of light guiding fins. The heat dissipating fins are integrally extended from the heat dissipation surface for dissipating the heat energy, and the light guiding fins are integrally extended from the arrangement surface for reflecting the illumination light beam and guiding the illumination light beam to be projected along an illumination direction.

### FIELD OF THE INVENTION

The present invention relates to a heat dissipation module, and more particularly to a heat dissipation module integrally formed with a plurality of light guiding fins.

### BACKGROUND OF THE INVENTION

In the indoor illumination-design, it is usually necessary to determine the location and the illumination direction of the illumination assembly in accordance with user's habit of use. For example, in a living room, a user usually sits down on the sofa to watch TV program. Therefore, it is usually necessary to install an illumination assembly near the sofa, so as to provide sufficient illumination for the user.

However, once the TV and the sofa are moved to another place different from the original place, it may not provide sufficient illumination for the user any more. At this time, the user can install another illumination assembly in accordance with the new place where the sofa is located, or the user can remove the original illumination assembly and re-install it in accordance with the location of the sofa.

In order to meet the requirements, it is necessary to make the illumination assembly capable of providing illumination along a selected illumination direction. Generally, it is usually necessary to adjust a rotatable reflection assembly to a certain direction. By reflecting at least one illumination light beam projected from at least one light emitting member of the illumination assembly, the illumination assembly is able to guide the illumination light beam being projected along the selected direction.

Based on above description, an embodiment provided in accordance with prior arts is disclosed. Please refer to FIG. 1, which illustrates a typical light guiding technology of an illumination assembly. As presented in FIG. 1, an illumination assembly 1 mainly comprises a heat dissipation module 11, three light emitting members 12, 12a, and 12b, and three reflection assemblies 13, 13a and 13b.

The heat dissipation module 11 comprises a heat dissipation base 111 and a plurality of heat dissipation fins 112. The heat dissipation base 111 has a heat dissipation surface 111a and an arrangement surface 111b. The heat dissipation fins 112 are integrally extended from the heat dissipation surface 111a of the heat dissipation base 111. The light emitting members 12, 12a and 12b are arranged on the arrangement surface 111b and respectively project an illumination light beam IL0. In FIG. 1, only the illumination light beam IL0 projected from the light emitting member 12 is presented.

The reflection assemblies 13, 13a and 13b are respectively located on the projecting paths of the illumination light beams projected from the light emitting members 12, 12a and 12b. The reflection assembly 13 comprises a pivot 131 and a reflection plate 132. Similarly, the reflection assembly 13a comprises a pivot 131a and a reflection plate 132a, and the reflection assembly 13b comprises a pivot 131b and a reflection plate 132b.

From FIG. 1, it is obvious that when the illumination light beam IL0 is projected from the light emitting member 12 to the reflection plate 132, the illumination light beam IL0 will be reflected and projected along an illumination direction I0. In other words, the reflection assembly 13 can guide the illumination light beam IL0 to be projected along the illumination direction I0. Due to that the reflection assembly 13 comprises the pivot 131, it is able to adjust the angle of the reflection plate 132, so that the illumination light beam IL0 can be projected along any selected illumination direction.

However, in the typical light guiding technology, except for the heat dissipation module 11 and the light emitting members 12, 12a and 12b, it is still necessary to additionally assemble the reflection members 13, 13a and 13b. It is undoubted that additionally assembling the reflection members 13, 13a and 13b will bring added assembling cost and material cost. Hence, the inventor is of the opinion that it is necessary to develop a new heat dissipation module for an illumination assembly such that it will save the assembling cost and material cost as mentioned.

### SUMMARY OF THE INVENTION

In prior arts, the light guiding technology provided in prior arts needs much assembling cost and material cost. Therefore, the primary objective of the present invention is to provide a new thermal module, in which an optical design can be directly done thereon to carry out light guiding technology.

Means of the present invention for solving the problems as mentioned above provides a heat dissipation module. The heat dissipation module is applied to guide at least one illumination light beam projected from at least one light emitting member, and the heat dissipation module is also applied to release heat energy when projecting the illumination light beam. The heat dissipation module comprises a heat dissipation base, a plurality of heat dissipating fins, and a plurality of light guiding fins. The heat dissipating fins are integrally extended from the heat dissipation surface for dissipating the heat energy, and the light guiding fins are integrally extended from the arrangement surface for reflecting the illumination light beam and guiding the illumination light beam to be projected along an illumination direction.

In the preferred embodiment of the present invention, the light guiding fins comprises a substrate layer and at least one reflection layer covered the substrate layer. The reflection layer can be composed of at least one organic optical plating film or at least one metal-plated layer. Moreover, at least one protruded optical correction member can be formed on the reflection layer.

Comparing with the light guiding technology carried out by the illumination assembly as disclosed in prior arts, in the present invention, the heat dissipation module itself comprises the light guiding fins, so that it is able to directly accomplish the optical design for the light guiding fins. Therefore, it can effectively carry out light guiding technology without assembling any reflection assembly. It is obviously that it is able to save the associate added assembling cost and the material cost of the reflection assembly via the present invention.

The devices, characteristics, and the preferred embodiment of this invention are described with relative figures as follows.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 illustrates a typical light guiding technology of an illumination assembly;

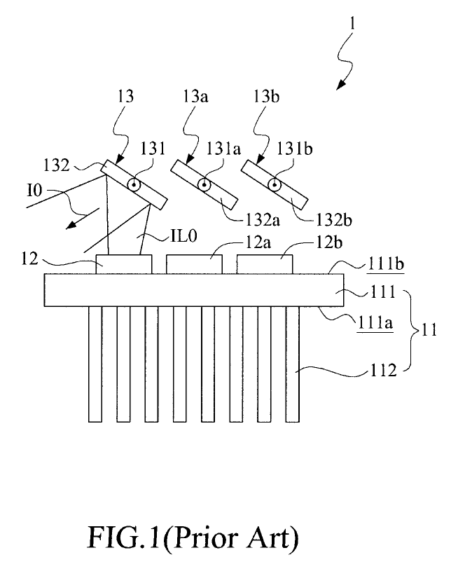

FIG. 2 illustrates that a heat dissipation module can guide at least one illumination light beam to be projected along an illumination direction in a first embodiment of the present invention;

FIG. 3 illustrates a partially cross sectional view of the region A in FIG. 2;

FIG. 4 illustrates that another heat dissipation module can guide at least one illumination light beam to be projected along another illumination direction in a second embodiment of the present invention;

FIG. 5 illustrates that another heat dissipation module can guide at least one illumination light beam to be projected along another illumination direction in a third embodiment of the present invention;

FIG. 6 illustrates that another heat dissipation module can guide at least one illumination light beam to be projected along another illumination direction in a fourth embodiment of the present invention;

FIG. 7 illustrates a partially cross sectional view of the region B in FIG. 6;

FIG. 8 illustrates the structure of another heat dissipation module in accordance with a fifth embodiment of the present invention;

FIG. 9 illustrates a partially cross sectional view of the region C in FIG. 8;

FIG. 10 illustrates the structure of another heat dissipation module in accordance with a sixth embodiment of the present invention; and

FIG. 11 illustrates a partially cross sectional view of the region D in FIG. 10.

### DETAILED DESCRIPTION OF THE PREFERRED EMBODIMENTS

In the present invention, the heat dissipation module itself comprises a plurality of light guiding fins, so that it is able to directly accomplish necessary optical designs for the light guiding fins to accordingly manufacture many kinds of illumination assemblies. Obviously, the combined applications of the present invention are too numerous to be enumerated and described, so that only six preferred embodiments are disclosed as follows for representation.

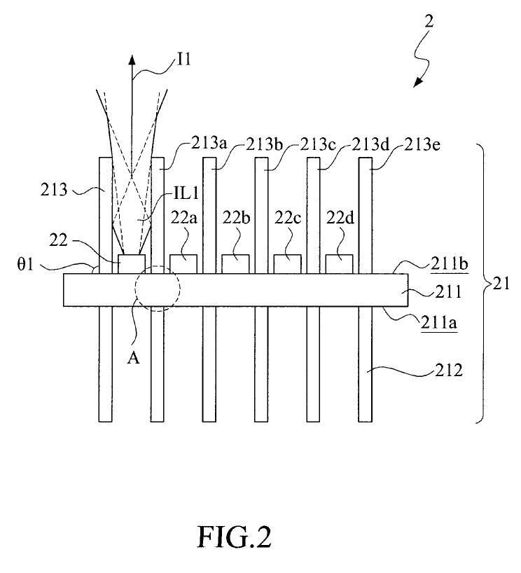

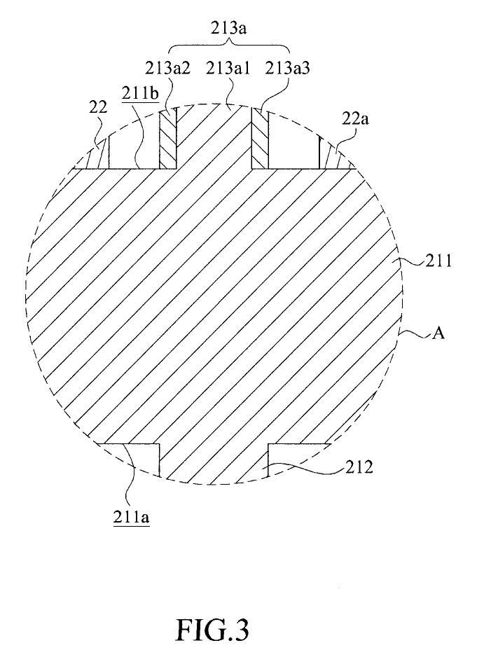

Please refer to FIG. 2 and FIG. 3, wherein FIG. 2 illustrates that a heat dissipation module can guide at least one illumination light beam to be projected along an illumination direction in a first embodiment of the present invention; and FIG. 3 illustrates a partially cross sectional view of the region A in FIG. 2. As shown in FIG. 2, an illumination assembly 2 mainly comprises a heat dissipation module 21 and five light emitting members 22, 22a, 22b, 22c and 22d. The heat dissipation module comprises a heat dissipation base 211, a plurality of heat dissipation fins 212 and six light guiding fins 213, 213a, 213b, 213c, 213d and 213e.

The heat dissipation base 211 has a heat dissipation surface 211a and an arrangement surface 211b opposite to the heat dissipation surface 211a, and the arrangement surface is arranged with the light emitting members 22, 22a, 22b, 22c and 22d. The heat dissipation fins 212 are integrally extended from the heat dissipation surface 211a, and the light guiding fins 213, 213a, 213b, 213c, 213d and 213e are integrally extended from the arrangement surface 211b, and a light-guiding angle θ1 is formed between the light guiding fin 213 and the heat dissipation base 211. In the first embodiment of the present invention, the light guiding angle θ1 is equal to 90 degrees. As shown in FIG. 3, the light guiding fin 213a comprises a substrate layer 213a1, two reflection layers 213a2 and 213a3, wherein the substrate layer 213a1 is integrally extended from the arrangement surface 211b, and the reflection layers 213a2 and 213a3 are covering the substrate layer 213a1. Due to that the structures of the rest light guiding fins 213, 213b, 213c, 213d and 213e are the same as or similar to the structure of the light guiding fin 213a, the related statements will not be repeated respectively.

Preferably, the substrate layer 213a1 can be made by an extrusive-forming treatment, and the reflection layers 213a2 and 213a3 can be composed of at least one organic optical plating film or at least one metal-plated layer. Furthermore, the reflection layers 213a2 and 213a3 can be composed of a composite material containing the organic optical plating film and the metal-plated layer. In the present invention, when the reflection layers 213a2 and 213a3 are composed of the metal-plated layer, it is suggested that the metal-plated layer can be made by plating silver (Ag), chromium (Cr), nickel (Ni), or barium (Ba). Additionally, the light emitting members 22, 22a, 22b, 22c and 22d can be light emitting diode (LED) members or other light sources being necessary to dissipate heat energy.

Please refer to FIG. 2, the light emitting members 22, 22a, 22b, 22c and 22d can respectively project an illumination light beam. In FIG. 2, only the illumination light beam IL1 projected from the light emitting member 22 is presented. When the illumination light beam IL1 is projected to the light guiding fins 213 and 213a, the illumination light beam IL1 will be reflected and projected along an illumination direction I1. Meanwhile, the heat dissipation fin 212 can dissipate heat energy, which generates when the light emitting member 22 projecting the illumination light beam IL1.

After reading the technology as disclosed in above description, it is believable that any person skilled in ordinary art can easily make out the light guiding effect and the illumination direction will be determined by the design of the light guiding fins, in which appeared shape, material characteristic, dimension, position and the light guiding angle of the light guiding fins are of importance. Following up, another five embodiments of the present invention will be further disclosed to illustrate the relation between the light guiding fins, the light guiding effects and the illumination directions.

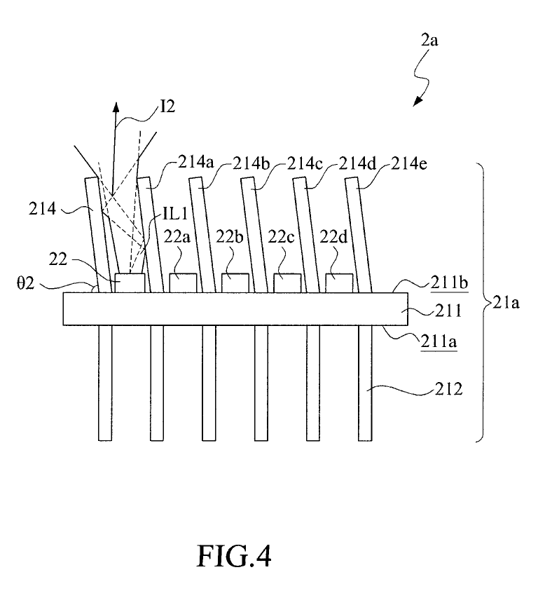

Please refer to FIG. 4, which illustrates that another heat dissipation module can guide at least one illumination light beam to be projected along another illumination direction in a second embodiment of the present invention. As shown in FIG. 4, in the second embodiment, another illumination assembly 2a is applied to replace the illumination assembly 2 of the first embodiment, and anther heat dissipation module 21a is applied to replace the heat dissipation module 21 of the first embodiment. The most obvious difference between the heat dissipation module 21a and 21 is that another six light guiding fins 214, 214a, 214b, 214c, 214d and 214e are applied to replace the light guiding fins 213, 213a, 213b, 213c, 213d and 213e, in which another light-guiding angle θ2 is formed between the light guiding fin 214 and the heat dissipation base 211, and the light-guiding angle θ2 is less than 90 degrees. From FIG. 4, in the second embodiment of the present invention, after the illumination light beam IL1 is reflected by the light guiding fins 214 and 214a, the illumination light beam IL1 will be guided to be projected along another illumination direction I2.

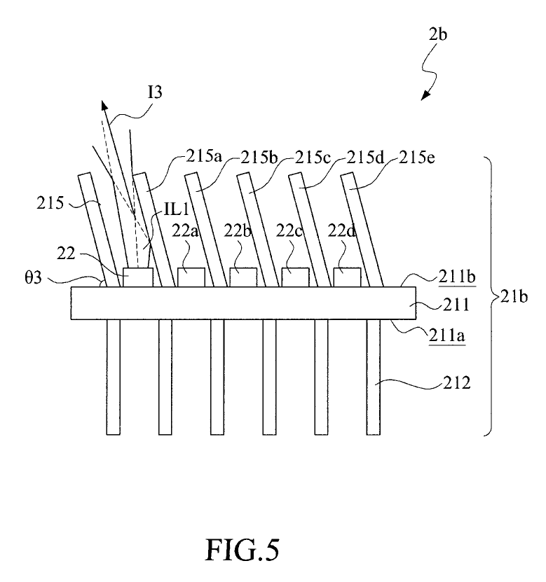

Please refer to FIG. 5, which illustrates that another heat dissipation module can guide at least one illumination light beam to be projected along another illumination direction in a third embodiment of the present invention. As shown in FIG. 5, in the third embodiment, another illumination assembly 2b is applied to replace the illumination assembly 2 of the first embodiment, and anther heat dissipation module 21b is applied to replace the heat dissipation module 21 of the first embodiment. The most obvious difference between the heat dissipation module 21b and 21 is that another six light guiding fins 215, 215a, 215b, 215c, 215d and 215e are applied to replace the light guiding fins 213, 213a, 213b, 213c, 213d and 213e, in which another light-guiding angle θ3 is formed between the light guiding fin 215 and the heat dissipation base 211, and the light-guiding angle θ3 is less than the light-guiding angle θ2 as mentioned in the second embodiment. From FIG. 5, in the third embodiment of the present invention, the illumination light beam IL1 is only reflected by the light guiding fin 215a. After that, the illumination light beam IL1 will be guided to be projected along another illumination direction I3.

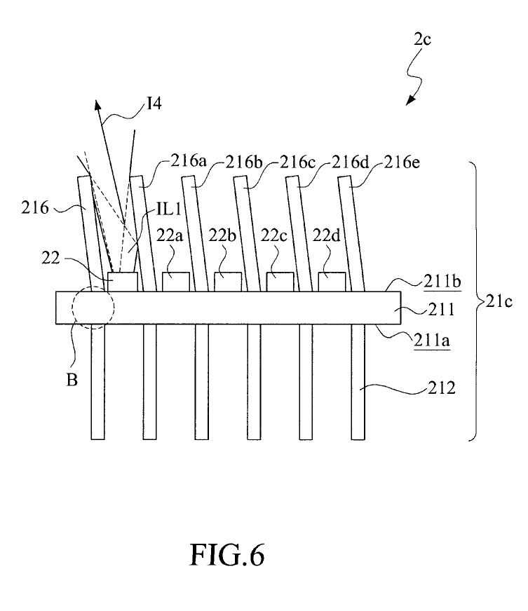

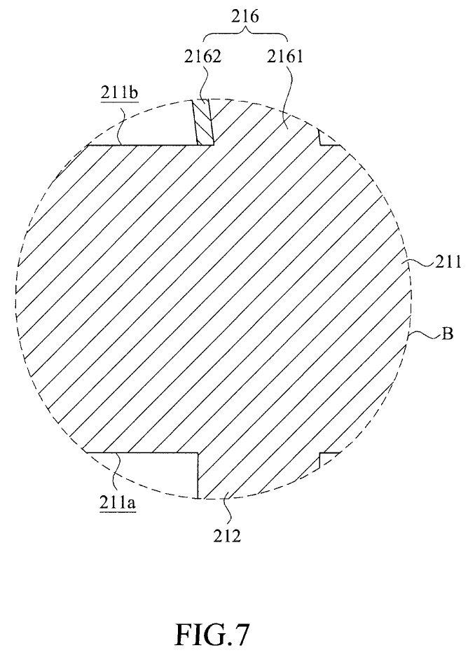

Please refer to FIG. 6 and FIG. 7, wherein FIG. 6 illustrates that another heat dissipation module can guide at least one illumination light beam to be projected along another illumination direction in a fourth embodiment of the present invention; and FIG. 7 illustrates a partially cross sectional view of the region B in FIG. 6. As shown in FIG. 6, in the fourth embodiment, another illumination assembly 2c is applied to replace the illumination assembly 2 of the first embodiment, and anther heat dissipation module 21c is applied to replace the heat dissipation module 21 of the first embodiment. The most obvious difference between the heat dissipation module 21c and 21 is that another six light guiding fins 216, 216a, 216b, 216c, 216d and 216e are applied to replace the light guiding fins 213, 213a, 213b, 213c, 213d and 213e.

From FIG. 7, it is obvious that the light guiding fin 216 only comprises a substrate layer 2161 and a reflection layer 2162 covering one surface of the substrate layer 2161. Referring to FIG. 6, in the fourth embodiment, although the illumination light beam IL1 can be projected both to the light guiding fins 216 and 216a, only the illumination light beam IL1 projected to the light guiding fin 216a would be reflected. The illumination light beam IL1 projected to the light guiding fin 216 is hardly reflected. Therefore, the illumination light beam IL1 can be guided to be projected to another illumination direction I4.

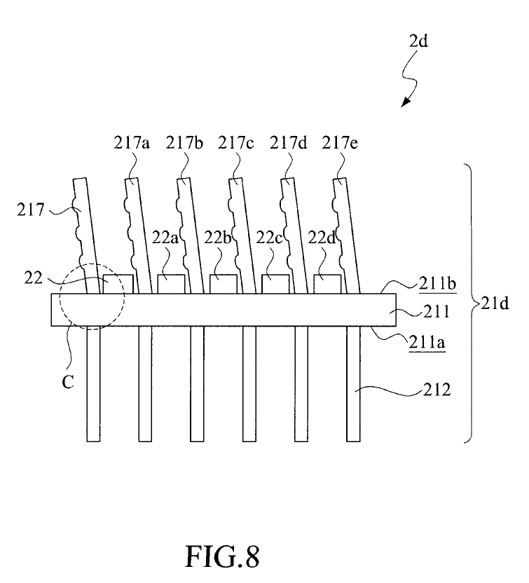

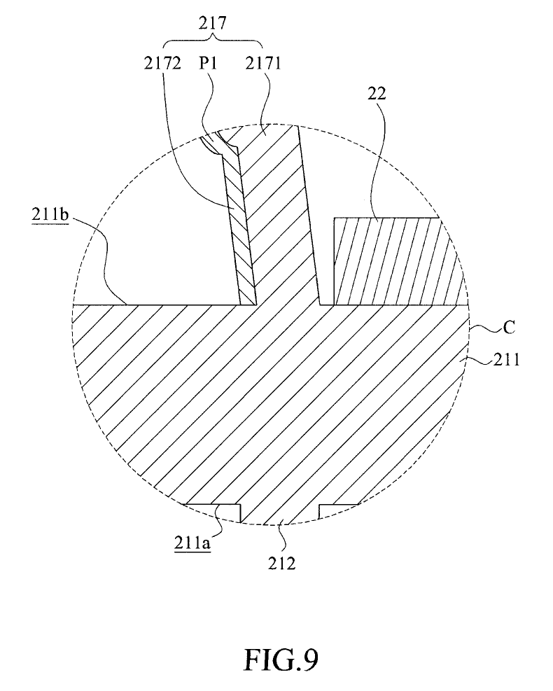

Please refer to FIG. 8 and FIG. 9, wherein FIG. 8 illustrates the structure of another heat dissipation module in accordance with a fifth embodiment of the present invention; and FIG. 9 illustrates a partially cross sectional view of the region C in FIG. 8. As shown in FIG. 8, in the fifth embodiment, another illumination assembly 2d is applied to replace the illumination assembly 2 of the first embodiment, and anther heat dissipation module 21d is applied to replace the heat dissipation module 21 of the first embodiment. The most obvious difference between the heat dissipation module 21d and 21 is that another six light guiding fins 217, 217a, 217b, 217c, 217d and 217e are applied to replace the light guiding fins 213, 213a, 213b, 213c, 213d and 213e. From FIG. 9, it is obvious that the light guiding fin 217 only comprises a substrate layer 2171 and a reflection layer 2172 covering one surface of the substrate layer 2171. Additionally, the reflection layer 2172 is formed with at least one protruded optical-correction member P1. Similarly, in the rest of light guiding fins 217a-217e, the reflection layers also can be respectively formed with other optical-correction members the same as or similar to the optical-correction member P1, so as to respectively carry out proper optical-correction for the illumination light beams projected form the light emitting members 22-22d.

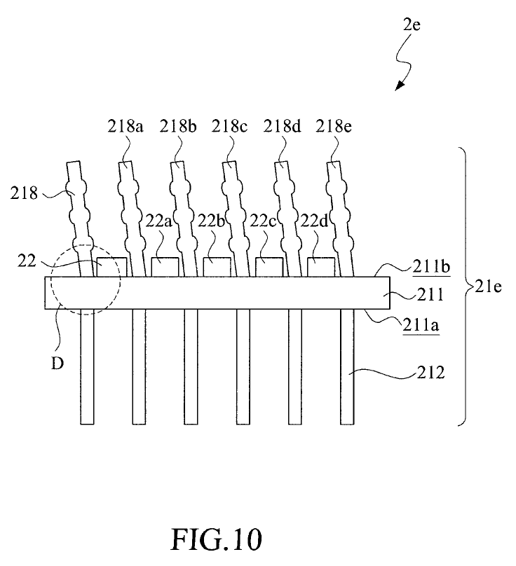

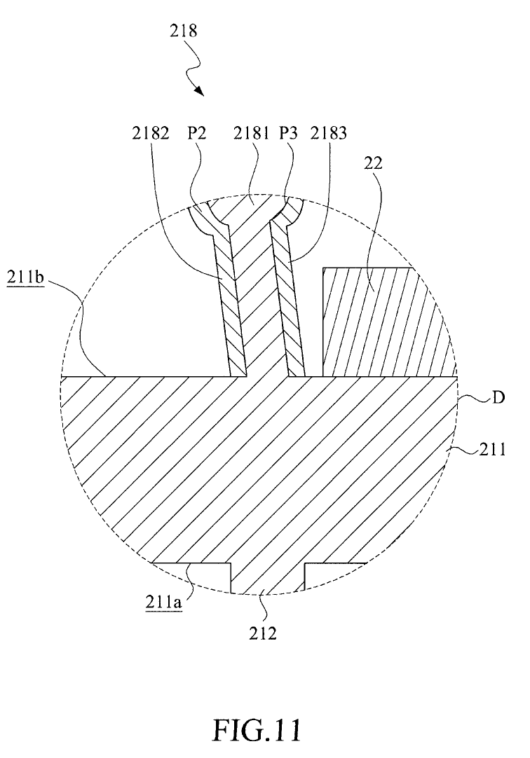

Please refer to FIG. 10 and FIG. 11, wherein FIG. 10 illustrates the structure of another heat dissipation module in accordance with a sixth embodiment of the present invention; and FIG. 11 illustrates a partially cross sectional view of the region D in FIG. 10. As shown in FIG. 10, in the sixth embodiment, another illumination assembly 2e is applied to replace the illumination assembly 2 of the first embodiment, and anther heat dissipation module 21e is applied to replace the heat dissipation module 21 of the first embodiment. The most obvious difference between the heat dissipation module 21e and 21 is that another six light guiding fins 218, 218a, 218b, 218c, 218d and 218e are applied to replace the light guiding fins 213, 213a, 213b, 213c, 213d and 213e. From FIG. 11, it is obvious that the light guiding fin 218 comprises a substrate layer 2181 and two reflection layers 2182 and 2183 covering two surfaces of the substrate layer 2181. Additionally, the reflection layer 2182 is formed with at least one protruded optical-correction member P2, and the reflection layer 2183 is formed with at least one protruded optical-correction member P3. Similarly, in the rest of light guiding fins 218a-218e, the reflection layers also can be respectively formed with other optical-correction members the same as or similar to the optical-correction member P2 and P3, so as to respectively carry out proper optical-correction for the illumination light beams projected form the light emitting members 22˜22d.

After reading the technology as disclosed in above description, it is believable that any person skilled in ordinary art can easily make clear that, in the present invention, the heat dissipation module itself comprises the light guiding fins, so that it is able to directly accomplish optical design for the light guiding fins. Through different optical designs, the heat dissipation module itself can have different abilities of light guiding. Therefore, it can effectively carry out light guiding technology without assembling any reflection assembly. It is obviously that it is able to save the assembling cost and the material cost of the reflection assembly via the present invention.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A heat dissipation module being applied to guide at least one illumination light beam projected from at least one light emitting member, and to release a heat energy when projecting the illumination light beam, and the heat dissipation module comprising:
a heat dissipation base, comprising:
a heat dissipation surface; and
an arrangement surface opposite to the heat dissipation surface, and provided for the light emitting member being arranged thereon;
a plurality of heat dissipating fins integrally extended from the heat dissipation surface for dissipating the heat energy; and
a plurality of light guiding fins integrally extended from the arrangement surface for reflecting the illumination light beam and guiding the illumination light beam to be projected along an illumination direction.

2. The heat dissipation module as claimed in claim 1, wherein each of the light guiding fins further comprises:
a substrate layer integrally extended from the heat dissipation surface; and
at least one reflection layer covered the substrate layer for reflecting the illumination light beam and guiding the illumination light to be projected along the illumination direction.

3. The heat dissipation module as claimed in claim 2, wherein the substrate layer is made by an extrusive-forming treatment.

4. The heat dissipation module as claimed in claim 2, wherein the reflection layer is composed of at least one organic optical plating film.

5. The heat dissipation module as claimed in claim 2, wherein the reflection layer is composed of at least one metal-plated layer.

6. The heat dissipation module as claimed in claim 5, wherein the metal-plated layer is made via plating silver.

7. The heat dissipation module as claimed in claim 5, wherein the metal-plated layer is made via plating chromium.

8. The heat dissipation module as claimed in claim 5, wherein the metal-plated layer is made via plating nickel.

9. The heat dissipation module as claimed in claim 5, wherein the metal-plated layer is made via plating barium.

10. The heat dissipation module as claimed in claim 1, wherein a light-guiding angle is formed between at least one of the light guiding fins and the heat dissipation base.

11. The heat dissipation module as claimed in claim 10, wherein the light guiding angle is equal to 90 degrees.

12. The heat dissipation module as claimed in claim 10, wherein the light guiding angle is less than 90 degrees.

13. The heat dissipation module as claimed in claim 1, wherein at least one of the light guiding films comprises at least one protruded optical-correction member.

14. The heat dissipation module as claimed in claim 1, wherein the light emitting member is at least one light emitting diode (LED) member.
